(19) United States
(12) Patent Application Publication
(10) Pub. No.: US 2026/0175226 A1
(43) Pub. Date: Jun. 25, 2026

(54) Wellplate Apparatus and Method for Filling Same

(71) Applicant: Agilent Technologies, Inc., Santa Clara, CA (US)

(72) Inventors: Jason Dell'Arciprete, Santa Clara, CA (US); Kellie Chadwick, Santa Clara, CA (US)

(21) Appl. No.: 18/707,230

(22) PCT Filed: Nov. 9, 2022
(86) PCT No.: PCT/US2022/049381

§ 371 Date: May 3, 2024

Related U.S. Application Data
(60) Provisional application No. 63/277,363, filed on Nov. 9, 2021.

(51) Int. Cl. B01L 3/00

(52) U.S. Cl. CPC B01L 3/50853; B01L 2300/041; B01L 2300/0829; B01L 2300/0851; B01L 2300/10; B01L 2300/18; B01L 2400/086

(57) ABSTRACT

A wellplate is disclosed containing a significant number of individual wells for holding and testing biological samples. In order to maintain homeostatic conditions within each well, the wellplate includes a moat that surrounds a perimeter of the wells. The moated wellplate is designed to be efficiently filled with fluids without causing fluid spills. Once filled with fluids, the moat prevents temperature gradients and different evaporation rates from occurring within the individual wells.

### RELATED APPLICATIONS

The present application is based upon and claims priority to U.S. Provisional Patent Application Ser. No. 63/277,363, filed on Nov. 9, 2021, and which is incorporated herein by reference in its entirety.

### BACKGROUND

When conducting cellular analysis, cells are commonly placed in a multi-well microplate for purposes of testing multiple conditions and replicates in a single experiment. The microplates can include multiple rows and/or columns of individual wells for testing a corresponding number of cellular samples simultaneously. Microplate arrays include some wells that are located at the border or along the edge of the microplate. For instance, the first row of wells, the first column of wells, the last row of wells, or the last column of wells form the border of the microplate. Border wells and non-border wells can experience different conditions. For example, there is a phenomenon commonly known as “edge effect” in which cellular samples contained in the border wells on the outside of the perimeter of the wellplate grow and behave differently than the cellular samples contained in wells that are not on the perimeter of the microplate. Such assays, for instance, are typically conducted at mammalian body temperature (e.g., 37° C.) which causes liquids to evaporate to a greater extent from the border wells in that the border wells are more exposed to the external environment. This increase in the evaporation rate in the border wells causes a temperature drop in the border wells due to evaporative cooling. Consequently, the edge effect can not only create fluid volume differences between the border wells and the non-border wells but can also result in a temperature difference and in a difference in the concentration of solutes in the liquid. These differences can contribute to data inconsistency.

Live-cell assays are particularly sensitive to the edge effect due to the dynamic nature of the assay and the sensitivity of living, metabolically active cells to the environmental conditions in which they are being measured. These differences can become exacerbated when the cellular samples are being heated in an incubator.

In addition to creating different conditions within the border wells and the non-border wells, the edge effect can also have other detrimental disadvantages. For instance, cellular samples contained in the border wells have a tendency to congregate towards the well side walls in response to the thermal gradient that is created along the border wells. When combined with an optical assay technique, which may be sensitive to position within a well, the effect can be an increase in well-to-well variability within the measurement, imaging, or monitoring assays.

The problems caused by edge effect are significant enough that it is somewhat common practice to not populate the wells on the perimeter of the microplate when running assays. Not populating the border wells, however, sacrifices testing capacity, requires more testing cycles to be completed, and therefore leads to inefficiencies in time and labor.

In order to address issues caused by the edge effect in microplate assays, U.S. Pat. No. 10,118,177 entitled “Single Column Microplate System and Carrier For Analysis of Biological Samples” discloses a column of wells that are surrounded on each side by moat compartments that are designed to maintain homeostatic conditions within the wells. The '177 patent is herein incorporated by reference.

Although the '177 patent provided great advances in the art, further improvements are still needed. In particular, a wellplate design is needed that contains a significant amount of wells arranged in rows and columns that is designed to counteract the edge effect phenomenon that is typically encountered with larger wellplates. In this regard, the present disclosure is directed to an improved wellplate design and method.

### SUMMARY

In general, the present disclosure is directed to a moated wellplate that is particularly well suited to preventing the edge effect phenomenon from occurring within the perimeter wells. The present disclosure is also directed to a method for transferring fluids to the wells and to moat compartments surrounding the wells in an efficient manner.

For example, in one embodiment, the present disclosure is directed to a wellplate comprising a well region having a perimeter. The well region comprises a plurality of wells arranged in a grid-like pattern including a plurality of rows and a plurality of columns. For example, the grid-like pattern can include from about 24 to about 1536 wells, such as from about 64 wells to about 384 wells. The grid-like pattern includes perimeter wells that surround a plurality of interior wells. The perimeter wells define the perimeter of the well region. In accordance with the present disclosure, the wellplate further includes a moat surrounding and adjacent to the perimeter of the well region for holding a liquid. The moat includes a first end channel opposite a second end channel and a first side channel opposite a second side channel. For example, in one aspect, the moat can be continuous around the perimeter of the well region. The wellplate further includes a plurality of fluid stabilizing barriers positioned within the moat. At least one fluid stabilizing barrier is positioned within the first end channel, within the second end channel, within the first side channel, and within the second side channel.

In one embodiment, a fluid stabilizing barrier is positioned in a middle region of the first end channel, a fluid stabilizing barrier is positioned in a middle region of the second end channel, a fluid stabilizing barrier is positioned in a middle region of the first side channel, and a fluid stabilizing barrier is positioned in a middle region of the second side channel. In one aspect, the wellplate can include four fluid stabilizing barriers as described above. In other aspects, however, a greater number of fluid stabilizing barriers may be included in the wellplate.

In one aspect, the first and second side channels can be narrower than the first and second end channels. The first and second end channels, however, may have a shorter length than the first and second side channels. Each side channel and each end channel can have substantially similar volumes. For instance, the first end channel, the second end channel, the first side channel, and the second side channel can have substantially equal fluid volume such that the fluid volumes do not vary by more than 10%. Alternatively, the end channels can have substantially equal volumes (e.g. not vary by more than 10%) and the side channels can have substantially equal volumes (e.g. not vary by more than 10%), but the end channels and the side channels can have different volumes that vary by more than 10%, such as by more than 15%, such as by more than 20% and less than about 100%.

The moat can be formed by opposing channel walls having a height. The fluid stabilizing barriers can terminate below a top of the channel walls which has been found to prevent fluids in the moat from sloshing or spilling from the moat compartments during movement. For example, the top of the fluid stabilizing barriers can terminate a distance of from about 0.1 mm to about 2 mm, such as from about 0.7 mm to about 1.3 mm from the top of the channel walls. The top of the channel walls can be coplanar with a top surface of the well region. The top surface of the well region can be defined by the top of the walls used to form the wells. The channel walls can form a perimeter of the well region and can form a portion of the perimeter wells.

The moat can have a depth that is more or less than the depth of the wells. For example, the moat can have a depth that is from about 1% to about 200% of the fluid depth of the wells. In one aspect, the moat can have a depth that is less than the depth of the wells. For instance, the fluid depth of the moat can be from about 30% to about 70% of the fluid depth of the wells. Alternatively, the moat can have a depth that is equal to or greater than the depth of the wells. For instance, the fluid depth of the moat can be from about 70% to about 150% of the fluid depth of the wells.

The moat compartments are designed to not only promote homeostatic conditions within the perimeter wells and the non-perimeter wells but are also designed to prevent fluids from spilling from the moat compartments during movement. In addition, the moat compartments can also include flow directors that are designed to facilitate flow of fluids within the moat compartments during filling. For example, in one aspect, each side channel can include a flow director. The flow director can include a first end that extends partially into the first end channel and a second end that extends partially into the second end channel. In one aspect, the flow director comprises a ridge that has a height of from about 0.1 mm to about 5 mm. In one embodiment, the first side channel can be in fluid communication with the first end channel and the second end channel. Similarly, the second side channel can also be in fluid communication with the first end channel and the second end channel.

The present disclosure is also directed to a method for adding fluids to a moated wellplate. The method includes dispensing doses of a fluid from a multi-channel pipette into the moated wellplate. The moated wellplate is as described above and can comprise a well region having a perimeter in which a plurality of wells are arranged in a grid-like pattern including a plurality of rows and a plurality of columns. The grid-like pattern includes perimeter wells that surround a plurality of interior wells. The wellplate further includes a moat surrounding and adjacent to the perimeter of the well region and includes a first end channel opposite a second end channel and a first side channel opposite a second side channel. Each row of the wellplate contains the same number of wells. The first and second end channels are parallel with the rows of wells and are in fluid communication with the first and second side channels. The multi-channel pipette includes a separate fluid dispensing tip for each well in a row.

In accordance with the method, fluid doses are dispensed from the multi-channel pipette simultaneously from each fluid dispensing tip in a row-by-row manner into the wellplate including dispensing fluid doses into the first end channel and into the second end channel for filling the moat with fluid. Alternatively, fluid doses can be dispensed from the multi-channel pipette simultaneously from each fluid dispensing tip in a column-by-column manner into the wellplate including dispensing fluid doses into the first end channel and into the second end channel for filling the moat with fluid.

In one embodiment, the wellplate includes a plurality of fluid stabilizing barriers positioned within the moat wherein at least one fluid stabilizing barrier is positioned within the first side channel and at least one fluid stabilizing barrier is positioned within the second side channel. The moat is continuous around the perimeter of the well region and broken up into at least two compartments by the fluid stabilizing barriers. The compartments are arranged such that dispensing fluid doses into the first end channel and dispensing fluid doses into the second end channel fills all the compartments with a fluid. For example, the moat can include L-shaped compartments. Each L-shaped compartment can extend at least partially along one of the end channels and extend partially along one of the side channels. In one embodiment, the amount of fluid dispensed into each row or into each column of wells on the wellplate by the multi-channel pipette is equal to the amount of fluid dispensed into each end channel for filling the moat.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a moated wellplate in accordance with the present disclosure;

FIG. 2 is a top view of the moated wellplate illustrated in FIG. 1;

FIG. 3 is a cross-sectional view of the moated wellplate illustrated in FIG. 1;

FIG. 4 is a bottom view of the moated wellplate illustrated in FIG. 1;

FIG. 5 is an enlarged view of a portion of the moated wellplate illustrated in FIG. 1 showing the height of a fluid stabilizing barrier;

FIG. 6 is a cross-sectional view of another embodiment of a moated wellplate in accordance with the present disclosure;

FIG. 7 is a perspective view of a cartridge adapted to mate with the moated wellplate illustrated in FIG. 1;

FIG. 8 is a perspective view of a cover that mates with the moated wellplate illustrated in FIG. 1;

FIG. 9 is a perspective view of one embodiment of a multi-channel pipette that may be used to dispense fluids into the wellplate of the present disclosure; and

FIGS. 10-11 are a graphical representation of some of the results obtained in the example below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

When cellular material is seeded into wellplates, there is a phenomenon commonly known as edge effect in which cells in the wells located on the perimeter of the wellplate grow and behave differently than the cellular material contained in the interior wells. Most notably, the perimeter wells experience a different environment than the interior wells which results in temperature differences and greater evaporation of fluids from the perimeter wells. The edge effect can have a negative impact on various analytical steps, including cell seeding, cell plate incubation, and running assays. In particular, all different types of bio-based assays can be negatively impacted including cell-based assays with adherent cells and live-cell assays in which label-free and extracellular flux measurements are being performed.

The present disclosure is generally directed to a wellplate design containing multiple rows and columns of wells that is configured to counteract the edge effect phenomenon such that the perimeter wells experience substantially the same environment as the interior wells. More particularly, the wellplate of the present disclosure includes a moat that can be broken up into compartments that are located adjacent to the perimeter wells of the wellplate. When fluid or media is dispensed into the moat, the fluid contained in the moat hydrates the air, creating a thermal and humidity buffer or condition to reduce the evaporation rate and minimize any thermal gradients that may occur between the fluid or cellular material contained in the perimeter wells and the fluid or cellular material that may be contained in the interior wells. The moated wellplate of the present disclosure offers numerous benefits and advantages when preparing, incubating, or taking cellular-based measurements on cellular material contained in the wellplate. For instance, the moated wellplate of the present disclosure can increase the incubation/hydration period of sensors used to take measurements. The moated wellplate can also increase assay duration. In addition, the moated wellplate can yield higher cell growth quality.

The moated wellplate design of the present disclosure is compatible with wellplate lids, covers, sensor cartridges, cell measurement/monitoring instruments, and other devices. Of particular advantage, the moat is designed and positioned on the wellplate such that the moat can be easily filled with fluids using the same procedure or process that is used to fill the wells with fluids. In this regard, the moated wellplate is particularly well suited for accommodating multi-channel pipettes in equal aspirate and dispense volumes that not only fill the moat or moat compartments with fluid but also fill the wells with a desired amount of fluid.

As will be described in greater detail below, the moated wellplate of the present disclosure can also include various different features that further improve the use and handling of the wellplate. For instance, the moat can be separated into compartments using fluid stabilizing barriers. The fluid stabilizing barriers can prevent against sloshing and spillage during handling or movement of the wellplate when filled with fluids. The fluid stabilizing barriers can also have a height that contributes to the meniscus height of the fluid contained in the moat for preventing the fluid from contacting a lid or cover and causing spillage due to wicking and fluid tension. In one embodiment, the moat can also include at least one flow director that can be located on a bottom surface of the moat for facilitating fluid distribution within the moat quickly and more evenly when fluids are dispensed into the moat.

Any suitable fluids can be received within the wells and moat of the present disclosure. The fluid, for example, can have any viscosity from low viscosity to high viscosity. In fact, the design of the present disclosure is particularly well suited to handling higher viscosity liquids, such as agar.

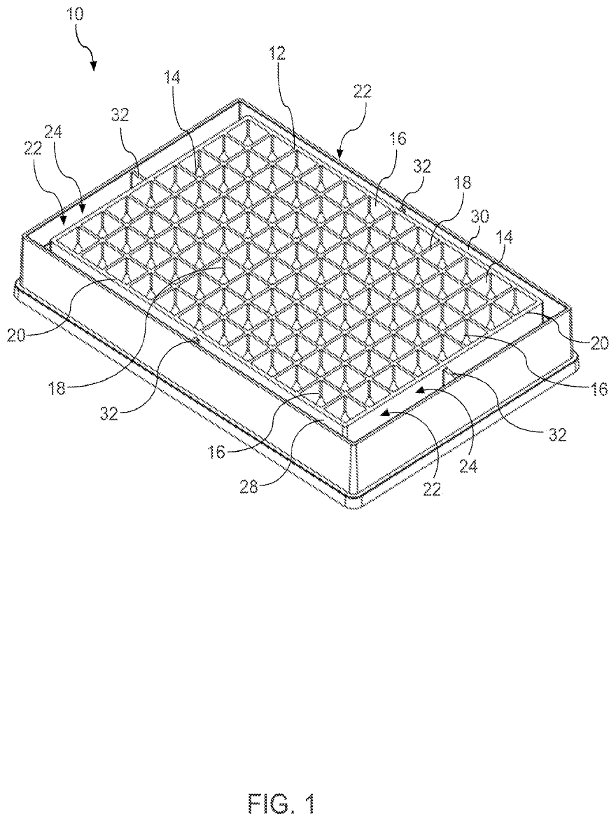

Referring to FIGS. 1-5, one embodiment of a wellplate 10 made in accordance with the present disclosure is shown. The wellplate 10 defines a well region 12 that comprises a plurality of wells 14. In the embodiment illustrated in FIG. 1, the wells 14 are arranged in a grid-like pattern that includes a plurality of rows of wells and a plurality of columns of wells. The wellplate 10 includes perimeter wells 16 that surround a plurality of interior wells 18. The perimeter wells 16 define a perimeter 20 of the well region 12.

In the embodiment illustrated in FIG. 1, the wellplate 10 includes 12 rows of wells and 8 columns of wells such that the wellplate 10 contains 96 individual wells 14. In the embodiment illustrated, the wells 14 all have substantially the same dimensions and fluid volumes.

The wellplate design of the present disclosure is particularly well suited to maintaining homeostatic conditions on a wellplate containing a significant number of wells. In this regard, wellplates made according to the present disclosure generally contain at least three rows of wells and at least three columns of wells such that there are a plurality of interior wells surrounded by perimeter wells. For instance, wellplates made according to the present disclosure can contain generally from about 20 wells to about 2,000 wells, including all increments therebetween. For instance, wellplates made according to the present disclosure can generally contain greater than about 20 wells, such as greater than about 40 wells, such as greater than about 60 wells, such as greater than about 80 wells, and generally less than about 1,600 wells, such as less than about 1,000 wells, such as less than about 700 wells, such as less than about 500 wells, such as less than about 300 wells. In one aspect, the wellplate can contain from about 64 wells to about 192 wells by adjusting the number of columns of wells, the number of rows of wells, and/or adjusting the number of wells in each column and the number of wells in each row.

Although the present disclosure is particularly well suited to wellplate designs having many wells, in other embodiments, the wellplate can include a single strip of wells and can have a well number of 1 to 1000, including all increments of 1 well number therebetween.

It should also be understood that although the wells 14 are arranged in a grid-like pattern on the wellplate 10 as shown in FIG. 1, other geometric shapes are also possible. For example, the wellplate 10 can also have a circular shape where the wells are arranged in concentric circles. As will be described in greater detail below, a grid-like pattern of wells as shown in FIG. 1 is particularly well suited for use with multi-channel pipettes and can facilitate not only depositing cellular material into the wells but also the fluids necessary for analytical testing.

In accordance with the present disclosure, the wellplate 10 as shown in FIGS. 1-5 further includes a moat 22 that surrounds the perimeter 20 of the well region 12. The moat 22 is designed to hold a fluid and act as a buffer to prevent against temperature gradients from forming between the perimeter wells 16 and the interior wells 18. Filling the moat 22 with a fluid, for instance, creates a thermal and humidity shield that reduces the evaporation rate of fluids from the perimeter wells 16 and minimizes the occurrence of thermal gradients over samples contained in the wellplate 10.

In the embodiment illustrated in FIGS. 1-5, the moat 22 is continuous around the perimeter 20 of the well region 12. In other embodiments, however, the moat may be discontinuous and be broken up into different moat sections. In the embodiment illustrated in the figures, the moat 22 includes a first end channel 24 opposite a second end channel 26 that are parallel to the rows of wells. The moat 22 further includes a first side channel 28 opposite a second side channel 30 that are perpendicular to the rows of wells and parallel to the columns of wells. The fluid volume of the end channels 24 and 26 and of the side channels 28 and 30 should be sufficient to prevent against thermal gradients or differences in humidity from forming within the wells 14 on the wellplate 10. In the embodiment illustrated in FIGS. 1-5, the end channels 24 and 26 are wider than the side channels 28 and 30. In this way, the end channels 24 and 26 can generally have the same fluid volume as the side channels 28 and 30. For example, in one embodiment, the volume of the end channels 24 and 26 is within about 10%, such as within about 7%, such as within about 5%, such as within about 3%, such as within about 1% of the volume of the side channels 28 and 30. Having the end channels 24 and 26 be similar in volume to the side channels 28 and 30 can facilitate filling the channels with fluid.

Alternatively, however, the end channels 24 and 26 can generally have the same fluid volume and the side channels 28 and 30 can generally have the same fluid volume, but the end channels and the side channels can have different volumes.

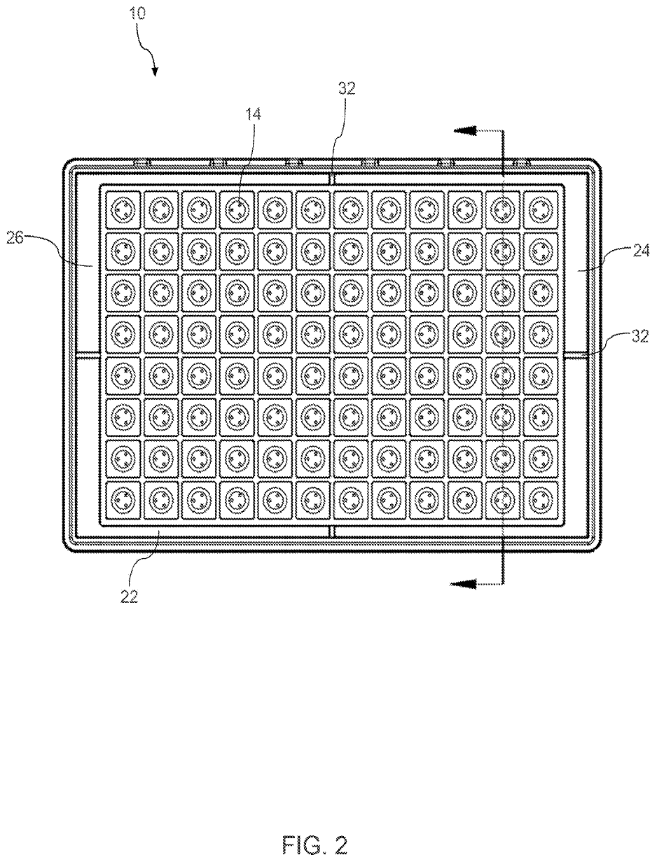

As shown in FIGS. 1, 2 and 5, the moat 22 can also include one or more fluid stabilizing barriers 32. The fluid stabilizing barriers 32 break the moat 22 into compartments. The fluid stabilizing barriers 32 are designed to prevent fluids contained within the moat 22 from sloshing and spilling during movement of the wellplate 10. In the embodiment illustrated in the figures, the wellplate 10 includes four fluid stabilizing barriers 32 for dividing the moat 22 into four equal L-shaped compartments. As shown in FIGS. 1 and 2, the four L-shaped compartments each extend along an end channel and along a side channel. The L-shaped compartments can have equal volumes. More particularly, it was discovered that placing the fluid stabilizing barriers 32 within a middle region of each end channel 24 and 26 and within a middle region of each side channel 28 and 30 is sufficient to prevent fluid spillage when the wellplate 10 is being handled or moved in a fluid-filled state. It should be understood, however, that the wellplate 10 may include more or less fluid stabilizing barriers 32 depending upon the particular application. For example, larger wellplates may require a greater number of fluid stabilizing barriers and the formation of a greater number of compartments. For example, in alternative embodiments, the side channels 28 and 30 can contain from about 2 to about 8 fluid stabilizing barriers, such as from about 2 to about 4 fluid stabilizing barriers. The end channels 24 and 26, on the other hand, can contain from about 2 to about 6 fluid stabilizing barriers, such as from about 2 to about 4 fluid stabilizing barriers.

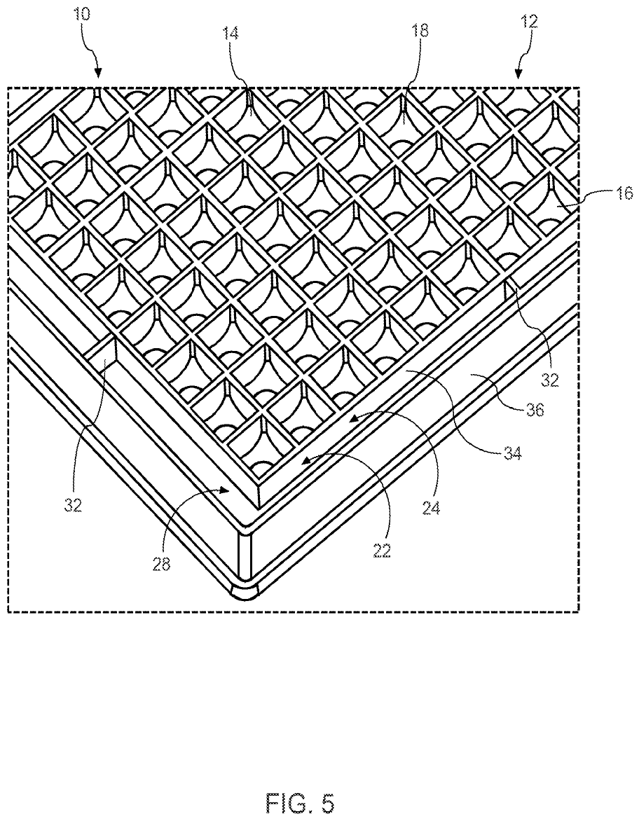

Referring to FIG. 5, two of the fluid stabilizing barriers 32 are shown in more detail. As shown, the moat 22 is formed by opposing channel walls. More particularly, the moat 22 is formed between an inner wall 34 and an outer wall 36. The inner wall 34 also serves as an outer wall of the perimeter well 16. In the embodiment illustrated in FIG. 5, the height of the outer wall 36 and the height of the inner wall 34 are equal. In addition, the height of the outer wall 36 is also coplanar with the top surface of the well region 12 that is defined by the top of the wells 14. In accordance with the present disclosure and as particularly shown in FIG. 5, the fluid stabilizing barriers 32 can have a height that terminates below the top of the channel walls 36 and 34. For example, the top of the fluid stabilizing barriers 32 can terminate a distance of from about 0.1 mm to about 3 mm from the top of the channel walls. More particularly, the fluid stabilizing barriers 32 can have a height that is at least about 0.1 mm, such as at least about 0.3 mm, such as at least about 1 mm, such as at least about 1.1 mm shorter than the height of the channel walls 34 and 36. The difference in height between the fluid stabilizing barriers 32 and the channel walls 34 and 36 is generally less than about 2 mm, such as less than about 1.7 mm, such as less than about 1.5 mm, such as less than about 1.3 mm. Having the height of the fluid stabilizing barriers 32 be less than the height of the channel walls 34 and 36 can provide various advantages and benefits. For example, it was discovered that the height of the fluid stabilizing barriers 32 can be used to control the dimensions and height of a meniscus of a fluid contained within the moat 22. Having the fluid stabilizing barriers 32 lower in height than the channel walls 34 and 36 prevents spilling of the fluid when the wellplate 10 is handled or moved.

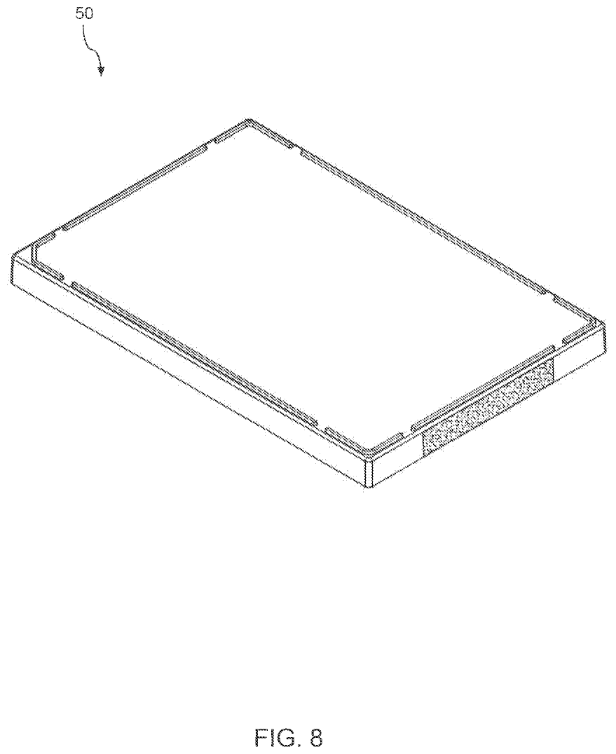

In many applications, the wellplate 10 is placed under a cover 50 as shown in FIG. 8. The cover 50 is placed over the wellplate 10, for instance, during periods of incubation. The cover 50 can prevent evaporation of fluids from the wells 14. The cover 50 when placed over the wellplate 10, can be designed to contact the channel walls 34 and 36 in order to form a tight fit with the wellplate 10. Fluids contained within the moat 22, however, can spill from the moat onto adjacent surfaces and other equipment due to wicking, intermolecular forces of the liquid, and/or capillary action. However, by constructing the wellplate 10 such that the fluid stabilizing barriers 32 have a lower height than the channel walls 34 and 36 controls the meniscus of the fluid contained within the moat 22 and the height of the liquid within the moat, thus preventing contact between the liquid and the cover 50. Thus, in accordance with the present disclosure, the height of the fluid stabilizing barriers 32 is used to control the height of the meniscus of a fluid contained within the moat 22 that in turn prevents spilling of the fluid over the walls 34 and 36 of the moat 22 when the cover 50 is placed on the wellplate 10.

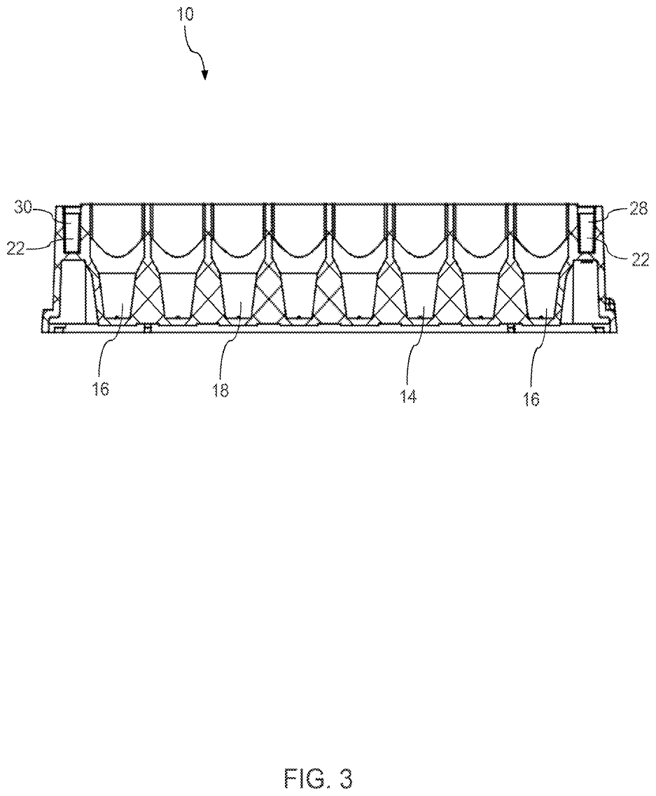

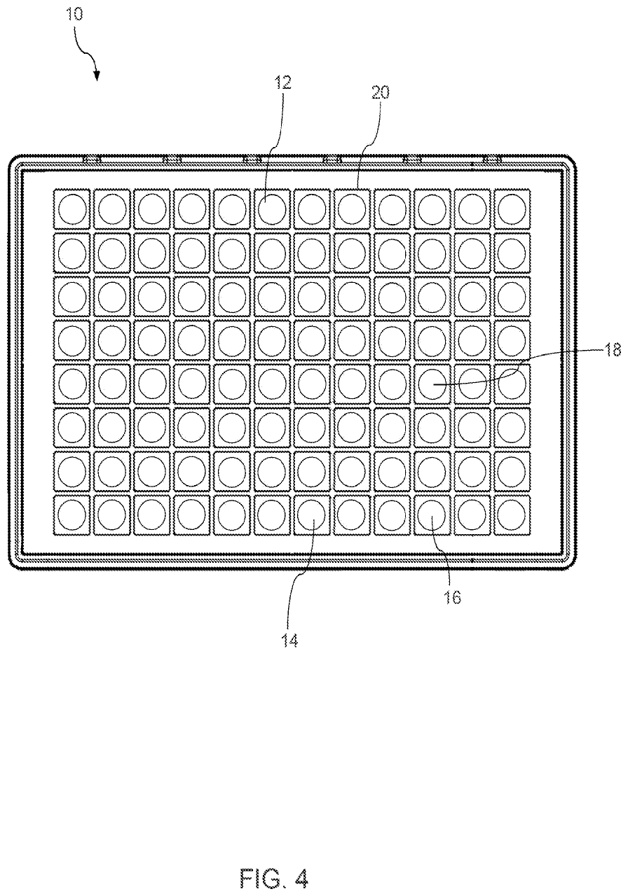

Referring to FIGS. 3 and 4, FIG. 3 illustrates a cross-section of the wellplate 10 illustrated in FIG. 1. FIG. 4 is a bottom view of the wellplate 10. As shown in FIG. 3, each of the wells 14 optionally have a top portion and a bottom portion. In the embodiment illustrated, the top portion has a square shape while the bottom portion has a tapered cylindrical shape. The bottom portion is particularly well suited for receiving a cellular sample contained in one or more fluids and for receiving a sensor for conducting various analytical tests. A seating surface may also be contained in each well 14 that acts as a positive stop for sensors that are inserted into the wells 14 for taking measurements. The seating surface can not only serve as a positive stop for a sensor but can also facilitate the creation of a localized reduced volume of medium that provides for more consistent and better uniformity of testing as discussed in U.S. Pat. No. 7,276,351, which is incorporated herein by reference.

A cross-section of the moat 22 is also illustrated in FIG. 3. In particular, FIG. 3 shows the first side channel 28 and the second side channel 30. As shown, the moat 22 along the side channels 28 and 30 are narrower than the wells 14. In particular, the side channels 28 and 30 have a width that is less than about 60%, such as less than about 50%, such as less than about 40%, and generally greater than about 10%, such as greater than about 20% of the width of each well 14. The end channels 24 and 26 can have a width that is generally greater than about 60%, such as greater than about 70%, such as greater than about 80%, and generally less than about 100%, such as less than about 95% of the width of each well 14. The wellplate 10 illustrated in FIGS. 1-5, however, merely represents one embodiment. In other embodiments, the moat 22 can be wider than each of the individual wells.

As shown in FIG. 3, the moat 22 generally is much shallower than the depth of the wellplates 14. For example, the depth of the moat 22 can be from about 30% to about 70% of the depth of the wells 14. For example, the depth of the moat 22 can be at least about 65% less, such as at least about 60% less, such as at least about 55% less, such as at least about 50% less than the depth of the wells 14. The depth of the moat 22 is generally greater than about 35%, such as greater than about 40% of the depth of the wells 14.

The above relationship of the moat 22 to the volume of the wells 14 has been found to create a sufficient barrier when filled with fluid for preventing against temperature gradients and differences in evaporation rates between the perimeter wells 16 and the interior wells 18.

It should be understood, however, that in other embodiments, the depth of the moat is anywhere of from about 1% to about 200% of the depth of the wells. In one embodiment, the moat 22 is slightly shallower than the depth of the wellplates 14 or is deeper than the wells. For example, the depth of the moat 22 can be from about 70% to about 150% of the depth of the wells 14. For example, the depth of the moat 22 can be at least about 80% greater, such as at least about 90% greater, such as at least about 100% greater, such as at least about 110% greater than the depth of the wells 14.

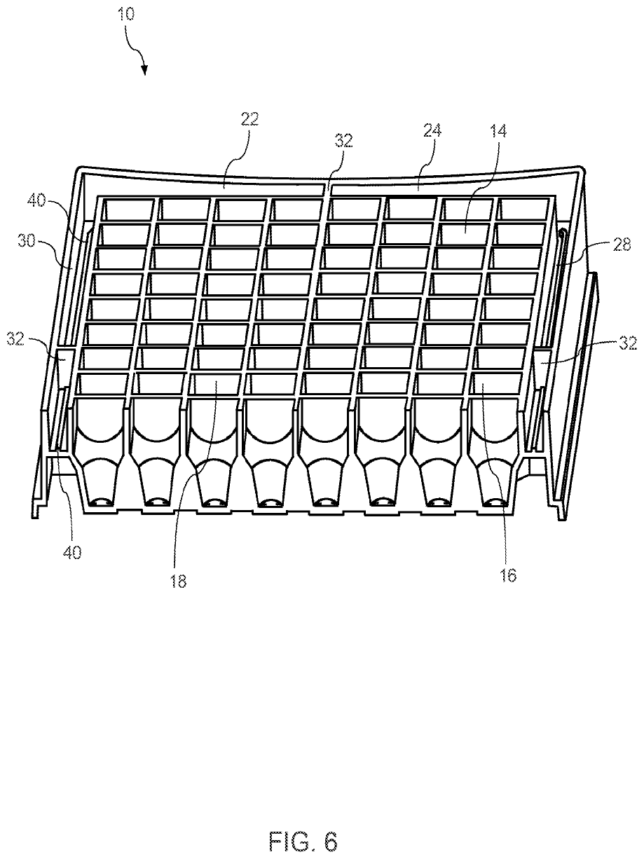

Referring to FIG. 6, an alternative embodiment of a wellplate 10 made in accordance with the present disclosure is shown. Like reference numerals have been used to indicate similar elements. As shown, the wellplate 10 includes a grid-like pattern of wells 14 that include perimeter wells 16 and interior wells 18. The wells 14 are surrounded by a moat 22. The moat 22 includes a first end channel 24, a second end channel (not shown), a first side channel 28, and a second side channel 30. Contained within the moat are fluid stabilizing barriers that prevent against fluid spillage and control fluid meniscus height.

In the embodiment illustrated in FIG. 6, the moat 22 further includes one or more flow directors 40. As shown, the flow directors 40 are located along the bottom of the moat 22. In the embodiment illustrated, the flow directors 40 are ridge-like structures that have a ridge with a vertical height.

The flow directors 40 are designed to facilitate filling of the moat 22 with a fluid. More particularly, the flow directors 40 break the surface tension of a fluid entering the moat 22. In this manner, a fluid being dispensed into the moat 22 flows evenly and creates a uniform height profile as the moat 22 is being filled with the fluid. In this manner, the flow directors 40 prevent against fluids from spilling as liquids are being dispensed into the moat.

In the embodiment illustrated in FIG. 6, fluid directors 40 are located along the entire length of the first side channel 28 and the second side channel 30. As shown, the fluid directors 40 further include curved ends that partially extend into the end channels, such as the first end channel 24 shown in FIG. 6. The curved ends of the flow directors 40 facilitate fluid flow from the end channels 24 and 26 into the side channels 28 and 30. In the embodiment illustrated in FIG. 6, the flow directors 40 are located within the side channels 28 and 30 where the moat 22 is narrower in relation to the end channels. In addition, as will be explained in greater detail below, in one embodiment, fluid is dispensed into the end channels 24 and 26 that then flows into the side channels 28 and 30. The flow directors 40 can greatly facilitate flow of a fluid from the end channels into the side channels.

As described above, the flow directors 40 in one embodiment define a ridge that has a height extending from the bottom of the moat 22. The ridge can generally have a height of greater than about 0.1 mm, such as greater than about 0.3 mm, such as greater than about 1 mm, such as greater than about 1.2 mm, such as greater than about 1.5 mm, such as greater than about 1.7 mm, such as greater than about 2 mm, such as greater than about 2.2 mm. The height of the ridge is generally less than about 5 mm, such as less than about 4 mm, such as less than about 3 mm.

The wellplate made according to the present disclosure can be formed from any suitable material. In one embodiment, for instance, the wellplate can be formed from a molded polymer composition. The polymer used to form the wellplate, for instance, can be polystyrene, polypropylene, polycarbonate, a polyethylene terephthalate, a polyvinyl chloride, a polycarbonate, a cyclic olefin copolymer, or a combination thereof or any other suitable material. The wells and the moat can be constructed from materials that are opaque, translucent, or transparent. In one embodiment, the bottom portion of the wells can be made from a transparent material while the upper portion can be opaque (e.g., colored a dark color) to reduce optical cross-contamination from one well to another. In another embodiment, the wells can be white in color, especially when taking luminescence measurements. In one embodiment, a coating agent can be deposited on at least one well of the wellplate. Examples of suitable coating agent include but is not limited to polymer coating agents. For instance, the polymer coating agent can be a poloxamer (e.g., Pluronic® F-127 or Pluronic® P-188) or a 2-methacryloyloxyethyl phosphorylcholine polymer or MPC polymer (e.g., Lipidure® from AMSBIO). Other examples of suitable coating agents include RinseAid from STEMCELL Technologies and BioFLOAT® from faCellitate. In another embodiment, the wellplate is suitable for microplate readers, multimode and absorbance readers, and imaging systems.

One particular device that has made great advances is the SEAHORSE analysis platform that is manufactured and sold by Agilent Technologies. The SEAHORSE analysis platform, for instance, can make quantitative measurements of mitochondrial function and cellular bioenergetics. For example, the instrument can measure oxygen concentration and pH in the extracellular media of a cell-based assay. Different aspects of the SEAHORSE analysis platform are described in U.S. Pat. Nos. 7,276,351, 7,638,321, 8,697,431, 9,170,253, U.S. Patent Publication No. 2014/0170671, U.S. Patent Publication No. 2015/0343439, U.S. Patent Publication No. 2016/0077083, and U.S. Patent Publication No. 2016/0096173, which are all incorporated herein by reference. The apparatus and methods of the present disclosure can be incorporated into the above-described devices for providing various advantages and benefits. The system and process of the present disclosure can also be incorporated into microplate readers including multimode and absorbance readers. For example, the detection system of the present disclosure can be incorporated into various exemplary devices including the SYNERGY Hybrid Multimode Readers, the CYTATION Hybrid Multimode Reader, the LOGPHASE Microbiology Readers, the EPOCH Microplate Spectrophotometers, the ELx808 Absorbance Reader, and the 800 TS Absorbance Reader all available through Agilent Technologies. In addition to polymer materials, the wells can also be formed from a glass. In one embodiment, the wells can be formed from a glass while the moat can be formed from a molded polymer material.

The wellplate 10 as shown in the figures can be used in conjunction with all different types of analytical equipment for conducting numerous different tests and assays. The wellplate 10, due to the presence of the moat 22, is particularly well suited for receiving cellular samples, such as viable cellular samples, and maintaining the samples in a homeostatic environment in one or more fluids. The wellplate 10 is also well designed for incubating cellular material prior to or during testing.

The wellplate 10, for instance, can be used to test two-dimensional adherent cells, all different types of suspension cells including two-dimensional suspension cells, three-dimensional bio-samples, and the like. The wellplate is also well designed to running assays on isolated mitochondria, spheroids, organoids, and the like. Applications that may be used in conjunction with the wellplate 10 include cellular or biomaterial identification and validation, pre-clinic safety toxicology, T-cell fitness assays, cell metabolism tests, compound screening, and cell signaling tests. The wellplate can be used to analyze biological material for cancer research, can be used for drug discovery and development, can be used to run all different types of immunology tests, and can be used in cardiovascular research. The wellplate 10 can also be used for stem cell analysis and testing. In addition, the wellplate 10 can be used in immuno-oncology tests.

Various instruments that can benefit from use of the moated wellplate of the present disclosure include cell metabolic analysis systems, microfluidic systems, microplate readers, multimode and absorbance readers, and imaging systems such as fluorescence lifetime imaging microscopy systems. One particular device that has made great advances is the SEAHORSE analysis platform that is manufactured and sold by Agilent Technologies. The SEAHORSE analysis platform, for instance, can make quantitative measurements of mitochondrial function and cellular bioenergetics. For example, the instrument can measure oxygen concentration and pH in the extracellular media of a cell-based assay. Different aspects of the SEAHORSE analysis platform are described in U.S. Pat. Nos. 7,276,351, 7,638,321, 8,697,431, 9,170,253, U.S. Patent Publication No. 2014/0170671, U.S. Patent Publication No. 2015/0343439, U.S. Patent Publication No. 2016/0077083, and U.S. Patent Publication No. 2016/0096173, which are all incorporated herein by reference. The wellplate of the present disclosure can be incorporated into the above-described devices for providing more consistent and uniform analytic testing.

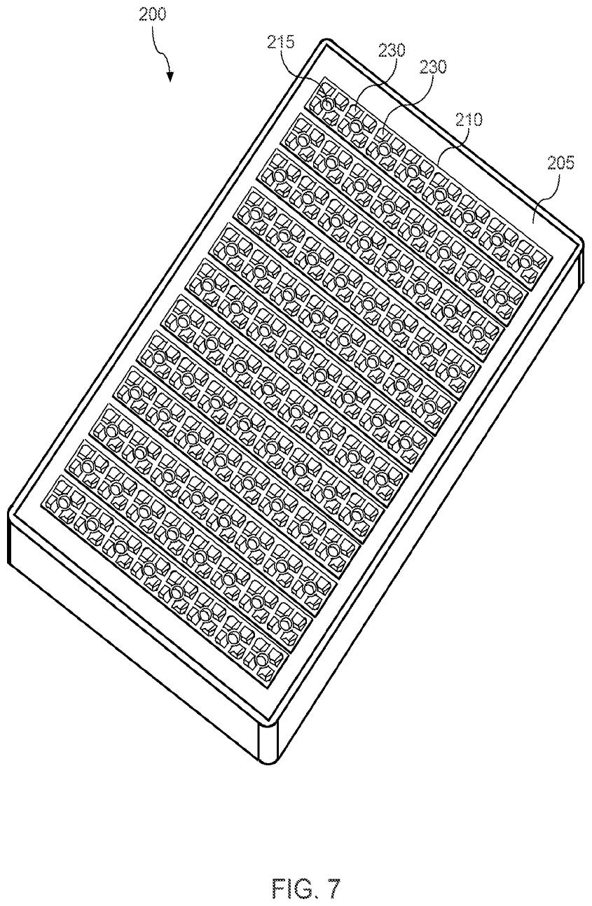

In one embodiment, the moated wellplate of the present disclosure is combined with a cartridge in conducting analytic testing. The cartridge, for instance, can not only be used to supply fluids to each of the wells 14 but can also include a guide for a sensor that is then inserted into the wells. For example, referring to FIG. 7, one embodiment of a cartridge 200 that may be used in conjunction with the wellplate 10 is illustrated.

The cartridge 200 has a generally planar surface 205 including a cartridge frame made, e.g., from molded plastic, such as polystyrene, polypropylene, polycarbonate, or other suitable material. Planar surface 205 defines a plurality of regions 210 that correspond to, i.e., register or mate with a number of the respective openings of a plurality of wells defined in the multi-well microplate 10. Within each of these regions 210, in the depicted embodiment, the planar surface defines first, second, third, and fourth ports 230, which serve as test compound reservoirs, and a central aperture that leads to a sleeve 215. Each of the ports is adapted to hold and to release on demand a test fluid to the respective well beneath it. The ports 230 are sized and positioned so that groups of four ports may be positioned over each well and test fluid from any one of the four ports may be delivered to a respective well. In other embodiments, the number of ports in each region may be less than four or greater than four. The ports 230 and sleeves 215 may be compliantly mounted relative to the multi-well microplate 10 so as to permit them to nest within the microplate by accommodating lateral movement. The construction of the cartridge to include compliant regions permits its manufacture to looser tolerances and permits the cartridge to be used with slightly differently dimensioned microplates. Compliance can be achieved, for example, by using an elastomeric polymer to form planar element 205, so as to permit relative movement between the frame 200 and the sleeves and ports in each region.

Each of the ports 230 may have a cylindrical, conic or cubic shape, open at planar surface 205 at the top and closed at the bottom except for a small hole, i.e., a capillary aperture, typically centered within the bottom surface. The capillary aperture is adapted to retain test fluid in the port, e.g., by surface tension, absent an external force, such as a positive pressure differential force, a negative pressure differential force, or alternatively a centrifugal force. Each port may be fabricated from a polymer material that is impervious to test compounds, or from any other suitable solid material, e.g., aluminum. When configured for use with a multi-well microplate 10, the liquid volume contained by each port may range from 500 μl to as little as 2 μl, although volumes outside this range can be utilized.

In each region of the cartridge 200, disposed between and associated with one or more ports 230, is the submersible sensor sleeve 215 or barrier, adapted to be disposed in the corresponding well. Sensor sleeve 215 may have one or more sensors 250 disposed on a lower surface 255 thereof for insertion into media in a well. One example of a sensor for this purpose is a fluorescent indicator, such as an oxygen-quenched fluorophore, embedded in an oxygen permeable substance, such as silicone rubber. The fluorophore has fluorescent properties dependent on the presence and/or concentration of a constituent in the well. Other types of known sensors may be used, such as electrochemical sensors, Clark electrodes, etc. Sensor sleeve 215 may define an aperture and an internal volume adapted to receive a sensor.

The cartridge 200 may be attached to the sensor sleeve or may be located proximal to the sleeve without attachment, to allow independent movement. The cartridge 200 may include an array of compound storage and delivery ports assembled into a single unit and associated with a similar array of sensor sleeves.

The cartridge 200 is sized and shaped to mate with multi-well microplate 10. Accordingly, in an embodiment in which the microplate has 96 wells, the cartridge has 96 sleeves.

The wellplate 10 in conjunction with the cartridge 200 is then well suited for being inserted into various different analytical systems including a system that can make quantitative measurements of mitochondrial function and cellular bioenergenetics as described above.

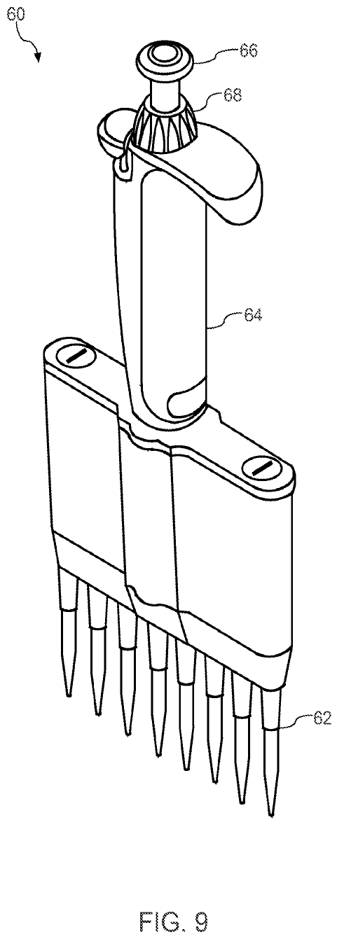

During use of the moated wellplate of the present disclosure, each of the wells are typically loaded with a biological sample for testing in conjunction with various fluids. The wellplate 10 made according to the present disclosure is uniquely designed so that the wells 14 and the moat 22 can be filled with fluids efficiently and at the same time. For instance, referring to FIG. 2, a top view of the wellplate 10 is illustrated showing the rows of wells 14 that are bordered by the first end channel 24 on one side and the second end channel 26 on the opposite side. In order to dispense fluids into the wellplate 10, in one embodiment, a multi-channel pipette may be used. For instance, FIG. 9 illustrates a perspective view of a multi-channel pipette 60. The multi-channel pipette 60 includes a plurality of fluid dispensing tips 62. As shown, the multi-channel pipette 60 can include 8 fluid dispensing tips 62 that matches the number of wells 14 in a row of wells on the wellplate 10. The multi-channel pipette 60 can include a grip component 64 and an actuation button 66. The multi-channel pipette 60 can also include an adjustment element 68 for adjusting the volumes that are dispensed by the fluid dispensing tip 62. Not shown, the multi-channel pipette 60 can include a plurality of cylinder/piston arrangements that are designed to dispense controlled and metered amounts of fluid through each dispensing tip 62.

The fluid dispensing tip 62 can be spaced apart a distance that is substantially equal to the distance between the center of the wells 14 as shown in FIG. 2. In this manner, the multi-channel pipette 60 can be used to dispense fluids into the wellplate 10 in a row-by-row manner (e.g. 8 doses) or alternatively in a column-by-column manner (e.g. 12 doses). In particular, equal volumes of fluid can be dispensed into each well along each row or along each column. In this manner, the multi-channel pipette 60 can be used to dispense 8 different fluid doses simultaneously 12 different times in order to fill all of the wells 14 on the wellplate 10 in a row-by-row manner. Alternatively, the multi-channel pipette 60 can be used to dispense 12 different fluid doses simultaneously 8 different times in order to fill all of the wells 14 on the wellplate 10 in a column-by-column manner.

In accordance with the present disclosure, the same multi-channel pipette 60 can also be used to fill the moat 22 on the wellplate 10 during the same process of filling the wells 14 in a row-by-row manner. For example, the pipette 60 can first dispense 8 doses of fluid into the first end channel 24. Afterwards, the pipette 60 can then fill each row of wells within the wellplate 10. After the wells 14 are filled, the pipette 60 can then dispense 8 doses of fluid into the second end channel 26. As shown in FIG. 2, the moat 22 is broken up into four L-shaped compartments by the fluid stabilizing barriers 32. In one embodiment, two of the L-shaped compartments can have a substantially similar volume as a row of wells. Thus, by dispensing 8 doses of fluid volume into the first end channel 24, one-half of the moat 22 becomes filled with fluid. By matching the volume of the compartments of the moat 22 with the volume of a row of wells 14, filling the moat with fluid in conjunction with the wells is greatly simplified, can be conducted very efficiently with less labor, and is less likely to result in fluid spills.

When filling the wells 14 in a column-by-column manner, the same multi-channel pipette 60 can also be used to fill the moat 22 on the wellplate 10 during the same process of filling the wells 14. For example, the pipette 60 can first dispense 12 doses of fluid into the first end channel 24. Afterwards, the pipette 60 can then fill each column of wells within the wellplate 10. After the wells 14 are filled, the pipette 60 can then dispense 12 doses of fluid into the second end channel 26. In this embodiment, two of the L-shaped compartments can have a substantially similar volume as a column of wells. Thus, by dispensing 12 doses of fluid volume into the first end channel 24, one-half of the moat 22 becomes filled with fluid.

The present disclosure may be better understood with reference to the following examples.

### Example No. 1

XF assays were run to evaluate the impact of a moat made in accordance with the present disclosure on edge effects. A wellplate was constructed as shown in FIG. 1 containing 96 assay wells. During the test, the four corner wells were left blank for background correction. The remaining 32 perimeter wells were compared to the interior 60 wells.

Four different cell lines were tested. The cell lines tested included C2C12, which is a myoblast cell line that is a subclone of a mouse myoblast cell line. Cell line A549 was also tested, which is a lung cancer cell line. The remaining two cell lines tested included HepG2, which is derived from liver tissue with a hepatocellular carcinoma, and MCF-7 cell line, which is a breast cancer cell line. The assays conducted included oxygen consumption rate (OCR) pmol of oxygen per minute (pmol/min) and proton efflux rate (PER) pmol of protons per minute (pmol/min).

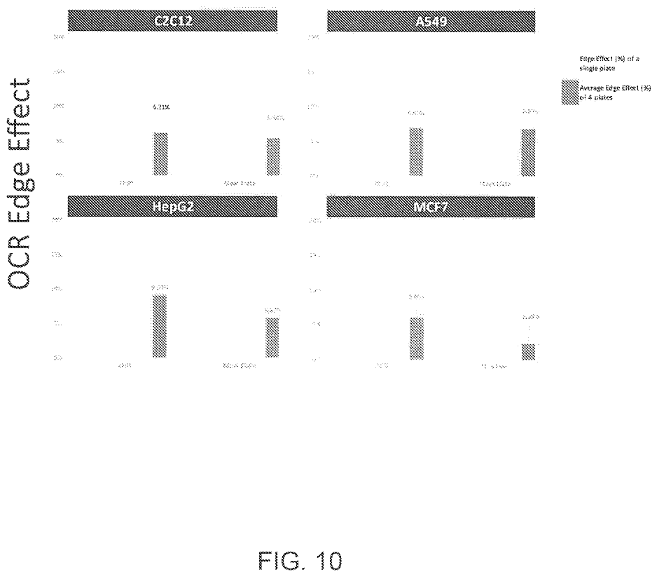

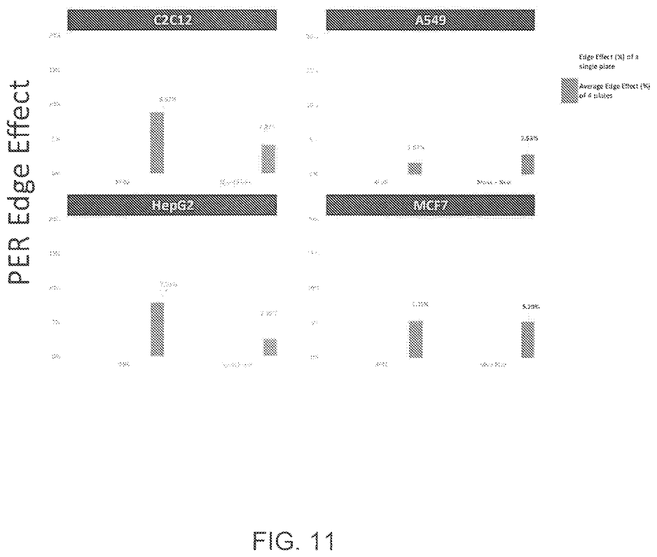

The wellplate made in accordance with the present disclosure was compared with a commercially available wellplate sold under the designation XF96 wellplate by Seahorse Bioscience. The results are illustrated in FIGS. 10 and 11. The data presented shows the percent difference of the average of the inner wells and the average of the outer wells when cells are respiring at their basal metabolic performance. This is the parameter used to quantify edge effects.

As shown in FIGS. 10 and 11, the wellplate made according to the present disclosure reduced the edge effect, particularly for the HepG2 cell line and the MCF-7 cell line, corresponding with the two cell lines that have slower attachment to the plate and frequently exhibit more significant edge effects in the commercially available XF96 wellplate.

A cell plate evaporation test was also conducted. The cell plate made according to the present disclosure was filled with water and subjected to a six hour XF assay at 37° C. to simulate a user experience. Assay wells were filled with 200 microliters of water each, while the moats were filled with 1,000 microliters of water per section. Upon completion of the assay, the volume of each well was measured by measuring the light absorbance of water with a plate reader. The absorbance is proportional to the liquid column height in each well, which can then be translated to volume. The test was conducted six different times and the results were averaged. The average difference in volume from well to well was found to be only 1.6%.

### Example No. 2

The moated well plate was designed to reduce evaporation in the perimeter wells and minimize cell seeding edge effects during incubation. This enables the use of the perimeter wells of a moat plate while achieving similar performance and increasing full-plate consistency. In some example experiments, users need long cell culture time in an incubator. During this time, evaporation may occur and impact the cell growth in the perimeter wells. In other experiments, users need to run assays of extended duration as cellular expressions can take time to develop. In this case, an example assay would be an extended XF assay, where metabolic phenotypes may take extended durations to be exhibited. During these extended assays, evaporation may cause measurement differences of cellular function in perimeter wells than inside wells. Reducing evaporation in extended measurement protocols will promote measurement consistency. In some cases, users may avoid placing samples in perimeter wells due to the potential for differences in performance. The moated plate addresses this challenge enabling a higher throughput and improved performance.

### Investigation of Evaporation of Moated and Stock Well Plate by Weight:

Method: Well volume will be determined by weight. Single well volume will be aspirated/dispensed on a scale to be weighed using a single channel pipettor after the assay. Prerequisite testing to determine errors for this methodology were also performed.
Assay 1: 37° C. sample temperature, 6-hour duration, 10 measurements per hour (1 measurement=3 min. mix/3 min. measure).
Assay 2: 37° C. sample temperature, 6-hour duration, 4 measurements per hour (1 measurement=3 min. mix/9 min. wait/3 min. measure).
Protocol: The following protocol was used for this experimentation.
Hydrate the cartridge in the utility wellplate overnight in a 37° C. non-CO2 incubator.

During cartridge calibration, prepare the moat wellplate:
For wells: Add 200 ul/well using an 8-channel pipettor
For Moat: Set 8-channel pipettor to 140 ul; fill moat with (2) dispenses for each of the (2) moat partitions (2,240 ul/partition or 4,480 total moat volume for the entire plate).

After the calibration is complete, remove the utility wellplate and install the moat wellplate, continue the assay.

After the assay is complete, remove the moat wellplate, then perform weight measurements to determine evaporation per well.
Notes: Aspirate/dispense error found to be at a minimum of 4 ul per well. Percent evaporated was calculated with 196 ul start volume. Absorption of fluid by prototyped moat plate is unknown/not taken into consideration to account for any error.

TABLE 1
Experimentation using Assay 1 method that evaluates the amount
of evaporation during a 6-hour XF assay, using a standard
XF protocol that included repeating a 3-minute mix and a
3-minute measure throughout. This results in approximately
10 measurements per hour. A total of three tests were run.

| Test | Plate type | Interior Wells | Perimeter Wells |
|---|---|---|---|
| Test 1 | Moated | 6.8% | 12.6% |
| Test 2 | Moated | 6.1% | 11.0% |
| Test 3 | Stock | 5.9% | 17.2% |

The data contained in Table 1 demonstrates that the perimeter well evaporation in the moated well plate was reduced even during a standard protocol.

TABLE 2
Experimentation using Assay 2 method that evaluates the amount of
evaporation during a 6-hour XF assay, using an extended XF protocol
that included a 3-minute mix, 9-minute wait, and a 3-minute measure.
This results in approximately 4 measurement periods per hour.

| Test | Plate type | Interior Wells | Perimeter Wells |
|---|---|---|---|
| Test 1 | Moat | 6.3% | 10.0% |
| Test 2 | Moat | 4.4% | 9.6% |
| Test 3 | Moat | 4.0% | 9.3% |

The data in Table 2 demonstrates that when an extended XF protocol is used, the evaporation of a moated plate is approximately 10% or less for perimeter wells. This is expected to improve performance of perimeter well samples during cell-based assays or experiments.

### Investigation of Evaporation of Moated Well Plate by Plate Reader:

Method: A moated 96-well plate was filled with 200 μL of water per well, and 1000 μL of water per moat section. The plate was subject to a 6-hour assay in an XF Pro Analyzer at 37° C. The assay protocol was modified to include 4 measurement cycles per hour. Upon completion of the assay, the volume of water in each well was measured using a plate reader. With this method, the light absorbance of water is proportional to the liquid column height in each well, which can then be translated to volume. The average of 6 replicates is shown below:

TABLE 3
Experimentation that evaluates the amount of evaporation during
a 6-hour XF assay, using an extended XF protocol that included
a 3-minute mix, 9-minute wait, and a 3-minute measure. A total
of 6 replicate tests were run and results were averaged.

| Test | Plate type | Interior Wells | Perimeter Wells |
|---|---|---|---|
| Average of 6 | Moated | 7.04% | 9.56% |
| Replicates | | | |

### Summary of Experimentation

Experimentation 1 and 2 data sets demonstrate that the evaporation seen in perimeter wells can be improved to approximately 10% or less for a six-hour XF essay using an extended measurement protocol. We also see in Experimentation 1 that the moated well plate performs superiorly when compared with the stock well plate during a six-hour assay using a standard XF protocol. This is advantageous to a user as this enables them to use perimeter wells and achieve comparable performance increasing the throughput of the assay.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A wellplate comprising:
a well region having a perimeter, the well region comprising a plurality of wells arranged in a grid-like pattern including a plurality of rows and a plurality of columns, the grid-like pattern including perimeter wells that surround a plurality of interior wells, the perimeter wells defining the perimeter of the well region;
a moat surrounding and adjacent to the perimeter of the well region for holding a liquid, the moat including a first end channel opposite a second end channel and a first side channel opposite a second side channel; and
a plurality of fluid stabilizing barriers positioned within the moat, wherein at least one fluid stabilizing barrier is positioned within the first end channel, within the second end channel, within the first side channel, and within the second side channel.

2. A wellplate as defined in claim 1, wherein the moat is continuous around the perimeter of the well region and broken up into compartments by the fluid stabilizing barriers.

3. A wellplate as defined in claim 1, wherein a fluid stabilizing barrier is positioned in a middle region of the first end channel, a fluid stabilizing barrier is positioned in a middle region of the second end channel, a fluid stabilizing barrier is positioned in a middle region of the first side channel, and a fluid stabilizing barrier is positioned in a middle region of the second side channel.

4. A wellplate as defined in claim 1, wherein the wellplate includes 4 fluid stabilizing barriers.

5. A wellplate as defined in claim 1, wherein the wellplate includes from about 24 to about 1536 wells.

6. A wellplate as defined in claim 1, wherein the first and second side channels are narrower than the first and second end channels.

7. A wellplate as defined in claim 1, wherein the first end channel, the second end channel, the first side channel, and the second side channel all have substantially equal fluid volumes such that the fluid volumes do not vary by more than 10%.

8. A wellplate as defined in claim 1, wherein the moat is formed by opposing channel walls having a height and wherein the fluid stabilizing barriers terminate below a top of the channel walls.

9. A wellplate as defined in claim 8, wherein a top of the fluid stabilizing barriers terminates a distance of from about 0.1 mm to about 2 mm, such as from about 0.3 mm to about 1.3 mm from the top of the channel walls.

10. A wellplate as defined in claim 8, wherein the well region has a top surface and wherein the top of the channel walls are coplanar with the top surface of the well region.

11. A wellplate as defined in claim 8 wherein one of the channel walls forms the perimeter of the well region and forms a portion of the perimeter wells.

12. A wellplate as defined in claim 1, wherein the moat has a depth and wherein the wells have a depth and wherein the depth of the moat is less than the depth of the wells.

13. A wellplate as defined in claim 12, wherein the depth of the moat is from about 1% to about 200% of the depth of the wells, such as from about 30% to about 70% of the depth of the wells, such as from about 70% to about 150% of the depth of the wells.

14. A wellplate as defined in claim 1, wherein the moat includes a bottom and at least one flow director is located along the bottom of the moat.

15. A wellplate as defined in claim 14, wherein each side channel includes a flow director, and wherein each flow director includes a first end that extends partially into the first end channel and a second end that extends partially into the second end channel.

16. A wellplate as defined in claim 14, wherein the at least one flow director comprises a ridge having a height of from about 0.1 mm to about 5 mm.

17. A wellplate as defined in claim 1, wherein the first side channel is in fluid communication with the first end channel and the second end channel and wherein the second side channel is in fluid communication with the first end channel and the second end channel.

18. A method for adding fluids to a moated wellplate comprising:
dispensing doses of a fluid from a multichannel pipette into the moated wellplate, the moated wellplate comprising a well region having a perimeter, the well region comprising a plurality of wells arranged in a grid-like pattern including a plurality of rows and a plurality of columns, the grid-like pattern including perimeter wells that surround a plurality of interior wells, the perimeter wells defining the perimeter of the well region, and a moat surrounding and adjacent to the perimeter of the well region including a first end channel opposite a second end channel and a first side channel opposite a second side channel, each row of the well plate containing a same number of wells, the first and second end channels being parallel with the rows and being in fluid communication with the first and second side channels, the multichannel pipette including a separate fluid dispensing tip for each well in a row; and
wherein the fluid doses are dispensed from the multichannel pipette simultaneously from each fluid dispensing tip in a row-by-row or column-by-column manner into the wellplate including dispensing fluid doses into the first end channel and into the second end channel for filling the moat with fluid.

19. A method as defined in claim 18, wherein the wellplate includes a plurality of fluid stabilizing barriers positioned within the moat, wherein at least one fluid stabilizing barrier is positioned within the first side channel and at least one fluid stabilizing barrier is positioned within the second side channel and wherein the moat is continuous around the perimeter of the well region and broken up into at least 2 compartments by the fluid stabilizing barriers and wherein the compartments are arranged such that dispensing fluid doses into the first end channel and dispensing fluid doses into the second end channel fills all the compartments with a fluid.

20. A method as defined in claim 19, wherein the moat includes L-shaped compartments, and wherein each L-shaped compartment extends at least partially along one of the end channels and extends partially along one of the side channels.
